(19) United States
(12) Patent Application Publication
(10) Pub. No.: US 2001/0002565 A1
(43) Pub. Date: Jun. 7, 2001

(54) CUTTING TOOL FOR THREADED FASTENERS

(76) Inventor: ROBERT E. KACHERGIUS, ORLAND PARK, IL (US)

Correspondence Address: SIMON B. ANOLICK, GARDNER CARTON & DOUGLAS, SUITE 3400, 321 NORTH CLARK STREET, CHICAGO, IL, 60610

(21) Appl. No.: 09/226,933

(22) Filed: Jan. 8, 1999

(51) Int. Cl. B26D 3/16

(52) U.S. Cl. 83/613; 30/241; 30/278

(57) ABSTRACT

The invention is a tool for shortening threaded fasteners which does not compromise the structural integrity of the cut end or its surrounding threading. The device comprises a c-shaped plate with blade retaining grooves having a plurality of threaded bores sized to match common commercially available fastener diameters, and a blade having a striking end and a cutting edge with an angle of preferably less than 30°. Fasteners to be cut are rotatably threaded in a clockwise direction through the threaded bores so that the portion to be cut extends through the plate. The blade is then inserted into the blade retaining grooves with the cutting edge resting on top of the uppermost fastener to be shortened. Pressure is applied to the striking end with a striking tool such as but not limited to a hammer, which causes the blade to move downward while severing the extended portion of the fasteners to be cut. The shortened fasteners are then removed from the tool by rotating the fasteners in a counter-clockwise direction. The present invention minimizes burring or thread deformation occurring during shortening and subsequent removal of the fastener.

### BACKGROUND OF THE INVENTION

1. Field of the Invention

The present invention relates to an improved tool for cutting threaded fasteners, such as bolts or screws. The fasteners are rotatably inserted into appropriately sized threaded bores in the tool so that the length to be cut extends perpendicularly outward from the surface of the tool, and pressure is applied to a slightly angled blade, which then cuts the extending portions of the fasteners.

2. Scope of the Prior Art

When repairing or constructing mechanical tools such as but not limited to machinery, airplanes and office machines, new or replacement threaded fasteners including but not limited to screws or bolts of varying lengths are often needed. Such screws, bolts and the like are commonly commercially available in over 20 diameters and 223 lengths.

In general, workmen such as mechanics and repair persons stock or carry with them only a small number of the most commonly sized screws and bolts or other threaded fasteners, as such items are heavy and impractical to stock in large numbers. Because of these problems, workmen must frequently use fasteners longer than are appropriate for the application, or the workman will cut, saw, chisel or grind the fastener to the desired length using bolt or pipe cutters, saws, chisels or other appropriate tools.

There are significant problems with these prior art tools. For instance, bolt and pipe cutters generally deform the end of the fastener and the threads so that the fastener cannot be inserted or removed from its bore after cutting. Chisels take a long time to accomplish the purpose and may severely damage the threads, and saws tend to be heavy and cumbersome (particularly for large diameter fasteners) and too powerful or large for smaller fasteners.

One improvement on these traditional methods for cutting fasteners is a bolt cutting tool having a chamber with an open top and bottom, and a blade which fits within the chamber. A pair of resilient abutments are positioned in the bottom of the chamber to absorb the striking force, and a tensioning abutment is needed for pretensioning the bolt to be cut and for “improving the character of the cut.” The bolts to be cut are inserted through appropriately sized threaded openings in the front wall of the tool. This prior art tool cuts the bolt with a single forked blade with two steeply angled cutting edges, each edge of which is angled in the range of 30°-60°, most optimally 45°. The inventor of this tool reports that when the angle of the cutting edge is less than 30°, the cutting edge dulls quickly and loses its effectiveness after a relatively short period of operation. In this prior art tool, the tapped bores are positioned such that a single angled vertical center line is formed for each column, which two lines intersect at a point above the bores.

This tool comprises multiple parts, some of which are readily difficult to manufacture (such as the forked blade), and requires some assembly and adjustment prior to use. In addition, it is hypothesized that the forked blade is difficult to sharpen, and that the tool as a whole is somewhat difficult and expensive to manufacture. Lastly, it is believed that this tool is not widely available.

In contrast to prior art tools and most particularly the tool immediately described above, the present invention comprises only two parts, is easy to manufacture and use, and utilizes a single edge blade with actuating angle of less than 30°. Surprisingly, in contrast to what is taught by the prior art described above, it is found that the blade of the present invention maintains it sharpness and ability to shear throughout extended use, and when sharpening is needed, it may be sharpened by any commonly used method of blade sharpening, such as but not limited to knife sharpening or grinding. The present invention also does not require adjustment prior to use.

### SUMMARY OF THE INVENTION

It is an object of the invention to provide a tool for cutting threaded fasteners that minimizes deformation of the threads and the cut surface of the fastener.

It is another object of the invention to provide a compact, portable and hand-operated tool for cutting threaded fasteners.

It is yet another object of the invention to provide a tool for cutting threaded fasteners that is easy to manufacture.

It is a further object of the invention to provide a tool for cutting threaded fasteners that may be used without adjustment of the tool.

It is a further object of the invention to provide a tool for cutting threaded fasteners of different sizes.

The invention is a tool for shortening threaded fasteners which does not compromise the structural integrity of the cut end or its surrounding threading. The device comprises a c-shaped plate with blade retaining grooves having a plurality of threaded bores sized to match common commercially available fastener diameters, and a blade having a striking end and a cutting edge with an angle of preferably less than 30°. Fasteners to be cut are rotatably threaded in a clockwise direction through the threaded bores so that the portion to be cut extends through the plate. The blade is then inserted into the blade retaining grooves with the cutting edge resting on top of the uppermost fastener to be shortened. Pressure is applied to the striking end with a striking tool such as but not limited to a hammer, which causes the blade to move downward while severing the extended portion of the fasteners to be cut. The shortened fasteners are then removed from the tool by rotating the fasteners in a counter-clockwise direction. The present invention minimizes burring or thread deformation occurring during shortening and subsequent removal of the fastener.

### BRIEF DESCRIPTION OF THE FIGURES

FIG. 1 is a front elevational view of a fastener cutting tool of the invention.

FIG. 2 is a longitudinal cross-sectional view of the tool of the invention along line 2-2 of FIG. 1.

FIG. 3 is a transverse cross-sectional view of the tool along line 3-3 of FIG. 1.

FIG. 4 is a transverse cross-sectional view of a second embodiment of the tool along line 3-3 of FIG. 1.

FIG. 5 is a schematic side view of the invention as used

### DETAILED DESCRIPTION OF THE PREFERRED EMBODIMENTS

The tool of the invention is designed to minimize damage to threads and cut ends of fasteners during cutting, thereby reducing or eliminating the need of filing, grinding, dressing, thread chasing, or any other secondary operational requirements to effect a relatively smooth and burr-free shortened threaded fastener. The tool of the invention is suitable for any threaded fastener having a generally cylindrical shank, such as but not limited to screws and bolts. The tool of the invention is also surprisingly suitable for shortening fasteners having a drilled shank, and for removing as little as a single thread from the shank of the fastener. The tool will cut fasteners made of most common fastener materials, including but not limited to plastics, rubbers, and various metals such as but not limited to steel, stainless steel, monel, aluminum, brass, bronze or any other metallic or non-metallic material or substance.

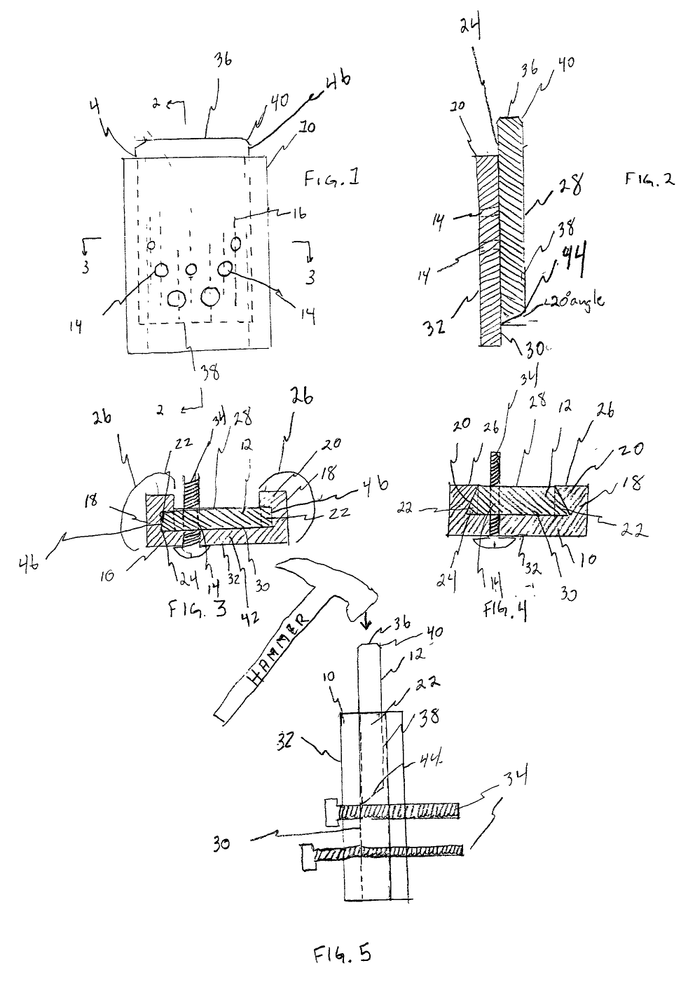

Referring to FIGS. 1-5, the tool includes only two parts, a C-shaped plate 10 and a blade 12, which blade 12 is designed to be slidably and removably inserted into the plate 10.

The C-shaped plate 10 contains two flanged portions 26 and a plate back 42, the plate back 42 having a shank side 30 and a head side 32, and plurality of threaded bores 14, as shown in FIGS. 1 and 3. Each bore has a vertical center axis, labelled “16” and shown for illustration purposes only in FIG. 1. The flanged portions 26 each include a vertical side 18, and a lip 20. The plate back 42 and flanged portions 26 enclose and defines a central space into which the blade is inserted, as shown in FIGS. 3 and 4. This space may be rectilinear as shown in FIG. 3, or it may be angled, one example of which is shown in FIG. 4. The flanged portions 26 and plate back 42 define two blade retaining grooves 22. The blade 12 has two vertical sides 46, which are slidably and removably received by the blade retaining grooves 22. The flanged portions 26 of plate 10 and the vertical sides 46 of blade 12 may be constructed with either right angles as shown in FIG. 3, or may be dovetailed (as shown in FIG. 4) or may be shaped in any other configuration suitable for use of the invention.

Each of the bores 14 is of a particular diameter and threaded so that each bore 14 may rotatably receive a threaded fastener 34 in sizes such as 10/32, 8/32, 10/24, 4-40, 6/32, ¼-28 or ¼-20, thus covering a range of commonly used fastener sizes. It is understood that the bore sizes are chosen based on commercial preferences, and depending upon the intended use for the fasteners, different bore sizes may be chosen depending upon the application desired.

The flanged portion 26 is designed to be slidably compatible with the blade 12, the blade 12 having a blade front 28 and a blade back 24. The blade 12 includes a striking end 36 and a cutting end, 38. The blade 12 is inserted into the blade retaining grooves 22, so that the blade back 24 is in partial contact with the shank side 30 of plate 10, and cutting end 38 is above the bores 14. When inserted into blade retaining grooves 22, the lip 20 of each flanged portion holds the blade 12 firmly within the blade retaining grooves 22. The thickness of blade 12 is slightly less than the thickness of the blade retaining means 22, so as to provide clearance for the movement of the blade 12. The blade striking end 36 has chamfered edges 40, which minimize chipping when struck.

In manufacturing the tool of the invention, it is necessary for smooth operation that the adjacent surfaces of the plate and the blade (30 and 24, respectively) be smooth and parallel, and it is important that the vertical sides 18 of the plate 10 be parallel. The dimension between the plate 10 and the blade 12 should be only enough so that smooth movement of the blade 12 may be accomplished, so that the blade 12 is guided downward linearly and has little or no opportunity to stray as a result of excessive clearance between the plate 10 and the blade 12. This dimension must also be small enough to minimize looseness of the blade 12 in the plate 10 during cutting, since the closer the blade is to the fastener being cut, the more cleanly the blade will cut. In the most preferred embodiment, this dimension is less than 0.004 inches, most preferably about 0.003 inches, although other dimensions may be suitable and are considered within the scope of the invention.

The tool is generally made of a high quality ferrous or non-ferrous material such as but not limited to metal, which material must be sufficiently strong to withstand striking forces while holding threaded fasteners in position while they are being cut. One preferable material for the plate 10 is 11 L 17 tool stock, a commonly available steel stock obtainable from a variety of sources, such as Central Steel and Wire (Chicago, Ill.). The plate 10 may be preferably hardened and/or tempered by any conventional means to provide strength and structural integrity to the tool.

Once the plate 10 is made to the appropriate size, The bores 14 are then drilled and tapped to any desired sizes. The number of bores can be greater or lesser than the openings pictured in FIG. 1. Each of the bores will be formed to a standard threaded pitch and/or diameter, or may be matched and threaded to a looser and different class of interference fit as necessity dictates. The threads are drilled from the head side 32 to the shank side 30 of plate 10, and may be aligned in either in a standard “V” form (as shown in FIG. 1), an inverted “V” form or other angled linear form, so long as the center lines 16 of the bores 14 are displaced from one another, as illustrated in FIG. 1. It is believed that this displacement of bores 14 imparts additional strength to the tool, since the cutting forces act in a downward manner and this placement maximizes the amount of material surrounding each bore 14, which material is believed to absorb a portion of the downward cutting forces. The plate 10 can be made to accommodate the cutting of threaded fasteners of various sizes in SAE, metric or other international thread designs.

In manufacturing the blade 12, the vertical dimension of the blade 12 is variable, but it is always greater than the vertical dimension of the plate 10. The blade 12 is received slidably and snugly within the blade retaining grooves 22 to fill the central portion (as illustrated in FIGS. 3 and 4), and its length permits the blade striking end 36 to project above the plate 10 both before and after use, thus minimizing wear on the plate 10. The blade 12 is most preferably made of a high quality and grade of tool steel (such as but not limited to 0-1 tool steel, a commonly available from a variety of sources, such as Central Steel and Wire in Chicago, Ill.), precision ground, hardened and tempered to fit into the plate with relatively close tolerances. The blade 12 may optionally be heat treated to provide additional strength and to help preserve its mechanical dimensions during repeated use. Heat treating also provides a more durable cutting edge 44. The cutting edge 44 extends transversely across the width of blade 12, is parallel to the face of the blade 12 and lies in the plane thereof. The cutting edge 44 is formed by beveling the end of the blade 12 upwardly and outwardly from the blade back 24 (which is adjacent to the shank side 30 of plate 10 during use), to the blade front 28, to provide an angled cutting surface, as illustrated in FIGS. 2 and 5. The cutting edge 44 of blade 12 is machined to an angle of less than 30°, preferably in the range from 12° to 25° and most preferably about 20°. The striking end 36 of blade 12 can be flat or slightly convex or rounded, as needed to accommodate efficient cutting action. In the most preferable embodiment, the upper edges and corners of striking end 36 will be chamfered 40 so as to minimize chipping.

To use the tool of the invention, The plate is held such that the fasteners 34 to be cut are inserted through the plate 10, from the head side 32 to the shank side 30. The portion of the fastener which extends into the central space is the portion which will be separated from the remainder of the fastener shank. The blade 12 is then inserted into the blade retaining means 22, and the tool is held upright, with the blade 12 resting upon the extending portion of the fastener, as illustrated in FIG. 5. The tool is placed on a solid surface such as a sturdy work bench, concrete surface or any other surface capable of withstanding a blow from a striking tool such as but not limited to a hammer. The tool body is then held in a vertical position by hand or other mechanical means. The operator then sharply strikes the blade striking end 36 of blade 12 with a striking tool such as but not limited to a hammer, thereby generating a downward force of sufficient magnitude to cause the blade to sever the extended portion of the threaded fastener 34 shank to be removed. Once the cutting operation is accomplished, the threaded fastener is removed from the tool body by rotating the fastener in a counter-clockwise movement.

While the tool of the invention may be used without lubrication, it may also be used with lubricants including but not limited to dry Teflon®, dry graphite, petroleum or mineral or synthetic oils or greases and other lubricants to assist or enhance its operational functions.

The tool of the invention can be uncoated, or it can be produced with a protective coating or plating such as parkerizing, phosphatizing, black oxide, electroplating or various other protective applications to minimize corrosion of the tool.

One optional feature of the invention (not shown) may be a scale imposed or imprinted along one edge of the tool in either metric or SAE units, to assist in measuring the before and after length of threaded fasteners being shortened. This scale, along with all other identification markings such as bolt diameters and thread depictions, may be applied to the face of the tool body by any conventional means such as stamping, etching, engraving, imprinting, laser marking or any other suitable means of application.

If the cutting edge 44 of blade 12 becomes dull, the edge may be sharpened by any conventional means, all of which are well known to those skilled in the art of sharpening blades.

It should be understood that various changes and modifications to the preferred embodiments described herein will be apparent to those skilled in the art. Such changes and modifications can be made without departing from the spirit and scope of the present invention and without diminishing its attendant advantages. It is therefore intended that such changes and modifications be within the scope of the claims.

What is claimed is:

1. A tool for cutting threaded fasteners consisting of:
(a) a plate comprising a plurality of threaded bores and a plurality of blade retaining grooves, wherein the bores are positioned so that the vertical center axis of each bore is displaced from the vertical center axis of all other bores; and
(b) a blade comprising a striking end, and an oppositely opposed cutting end having a cutting edge, wherein the cutting edge has an angle of less than 30°; wherein the blade is adapted to be removably and slidably inserted into the blade retaining grooves and to slidably traverse the threaded bores when force is applied to the striking end.

2. The cutting tool of claim 1, wherein the threaded bores are sized to receive standard, SAE, English and metric size fasteners or other international thread designs.

3. The cutting tool of claim 1 wherein the blade has a striking end and a cutting end and a blade back and a blade front, and further wherein the blade comprises a single cutting edge which is formed by beveling the cutting end upward and outward from the blade back to the blade front so that the blade angle is less than 30°.

4. The cutting tool of claim 3, wherein the striking end has chamfered edges.

5. The cutting tool of claim 1, wherein the plate further comprises flanged portions, which flanged portions define a blade retaining groove.

6. The tool of claim 1 wherein the cutting edge has an angle in the range of from 12° to 25°.

7. The tool of claim 1 wherein the cutting edge has an angle of approximately 20°.

8. A fastener cutting tool consisting of a plate and a blade, wherein the plate is adapted to slidably and removably receive and hold the blade during use, and further wherein the plate contains a plurality of threaded bores and the blade has a cutting edge with an angle of less than 30°.

9. The tool of claim 8 wherein the cutting edge has an angle in the range of from 12° to 25°.

10. The tool of claim 8 wherein the cutting edge has an angle of approximately 20°.

11. The tool of claim 8, wherein the plate comprises a plurality of flanged portions, which flanged portions define a blade retaining groove.

12. A tool for cutting threaded cylinders consisting of:
(a) a plate comprising a plurality of threaded bores and oppositely opposed flanged portions each defining a blade retaining groove, wherein the bores are positioned so that the vertical center axis of each bore is displaced from the vertical center axis of all other bores; and
(b) a blade comprising a chamfered striking end and an oppositely opposed cutting end, and a blade back and a blade front, wherein the cutting end comprises a single cutting edge which is formed by beveling the cutting end upward and outward from the blade back to the blade front, and further wherein the cutting edge has an angle of less than 30°, and further wherein the blade is adapted to be removably and slidably inserted into the blade retaining means and to slidably traverse the threaded bores when force is applied to the striking end.

13. The tool of claim 12, whereby a fastener may be caused to extend into the path of movement of the blade and whereby pressure is exerted onto the striking end of the blade causes the blade to downwardly remove the extending portion of the fastener being severed.
